(19) United States
(12) Patent Application Publication
(10) Pub. No.: US 2014/0324626 A1
(43) Pub. Date: Oct. 30, 2014

(54) SYSTEMS AND METHODS TO PRESENT ITEM RECOMMENDATIONS

(71) Applicants: Jonas Oscar Klink, White Plains, NY (US); Jason Allen Fletchall, San Jose, CA (US); Linh Nhat Vu Tran, San Francisco, CA (US); Christopher Michael Matthews, San Jose, CA (US)

(72) Inventors: Jonas Oscar Klink, White Plains, NY (US); Jason Allen Fletchall, San Jose, CA (US); Linh Nhat Vu Tran, San Francisco, CA (US); Christopher Michael Matthews, San Jose, CA (US)

(21) Appl. No.: 14/139,468

(22) Filed: Dec. 23, 2013

Related U.S. Application Data
(60) Provisional application No. 61/815,609, filed on Apr. 24, 2013.

(51) Int. Cl. G06Q 30/06

(52) U.S. Cl. CPC G06Q 30/0631
USPC 705/26.8

(57) ABSTRACT

A view item page that is descriptive of a current item may be displayed in response to a request to view a description of the current item. The view item page may include a control that is operable to display recommendations of further items similar to the current item that is described in the view item page. Upon detecting that a user has operated the control included in the view item page, the recommendations of the further items may be generated based on the current item described in the view item page. Moreover, the generated recommendations may be presented to the user that operated the control.

### RELATED APPLICATION

This application claims the priority benefit of U.S. Provisional Patent Application No. 61/815,609, filed Apr. 24, 2013, which is incorporated herein by reference in its entirety.

### TECHNICAL FIELD

This application relates generally to data processing, and more specifically, to systems and methods to provide one or more item recommendations.

### BACKGROUND

A shopper may browse item listings online. In some instances, the shopper may request item recommendations.

### BRIEF DESCRIPTION OF THE DRAWINGS

Some embodiments are illustrated by way of example and not limitation in the figures of the accompanying drawings.

FIG. 1 is a network diagram illustrating a network environment suitable to present one or more item recommendations, according to some example embodiments.

FIG. 2 is a block diagram depicting a recommendation machine, according to some example embodiments.

FIG. 3 is an example user interface displaying a list of items, according to some example embodiments.

FIG. 4 is an example user interface displaying a view item page, according to some example embodiments.

FIG. 5 is an example user interface displaying generated recommendations of items similar to an item described by a view item page, according to some example embodiments.

FIG. 6 is an example user interface displaying further generated recommendations of items similar to an item described by a view item page, according to some example embodiments.

FIGS. 7-9 are flowcharts illustrating a method for presenting recommendations, according to some example embodiments.

FIG. 10 is a diagrammatic representation of a machine in the example form of a computer system within which a set of instructions for causing the machine to perform any one or more of the methodologies discussed herein may be executed.

### DETAILED DESCRIPTION

A user may shop of items by searching for item listings online. The user may submit a search query to a search engine (e.g., an item recommendation machine configured to provide item recommendation service), which may result in retrieval of one or more item listings by the search engine. References (e.g., links) to these retrieved item listings may be presented by the search engine to the user via a device of the user. For example, the search engine may provide the device with a webpage that displays a set of links to the retrieved item listings, and the device may present the webpage and its links to the user. The user may select a reference to an item listing that is retrieved by the search query. Selection of the reference may result in the search engine providing another webpage that displays the corresponding item listing. The user may request recommendations of similar items based on the selected item listing. For example, the webpage for the item listing may include a control (e.g., a “find items similar to this item” button) that is operable by the user to request recommendations of similar items. The search engine (e.g., the item search machine) may present a results page that includes references to additional item listings recommended based on the selected item listing, in response to the request. The user may also customize the recommendations by providing one or more search criteria to the search engine. As a result, the search engine may present a modified results page of recommendations based on the search criteria received from the user.

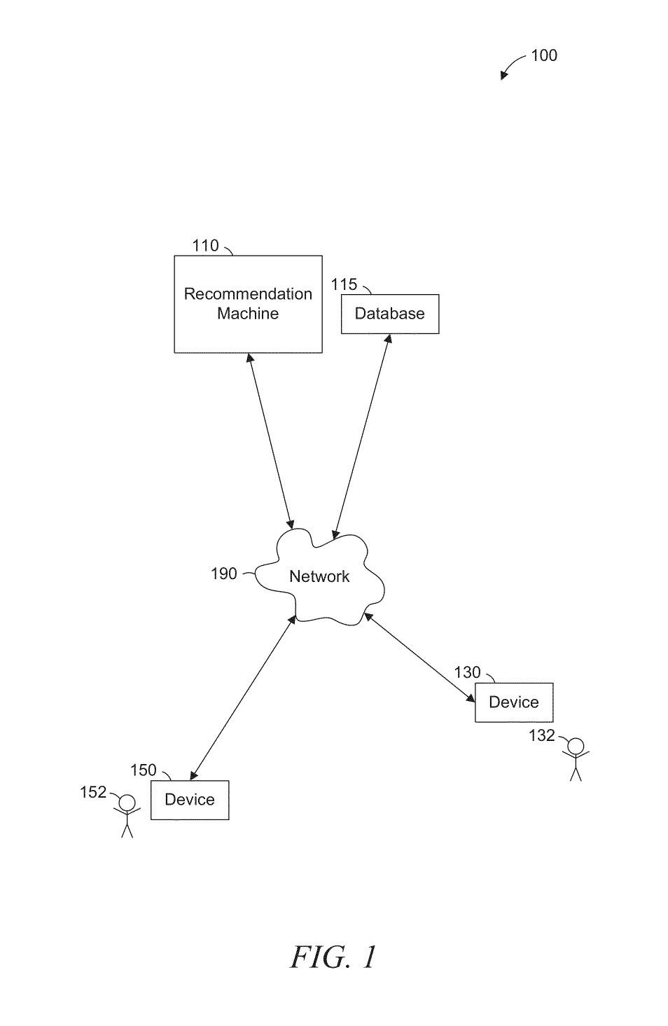

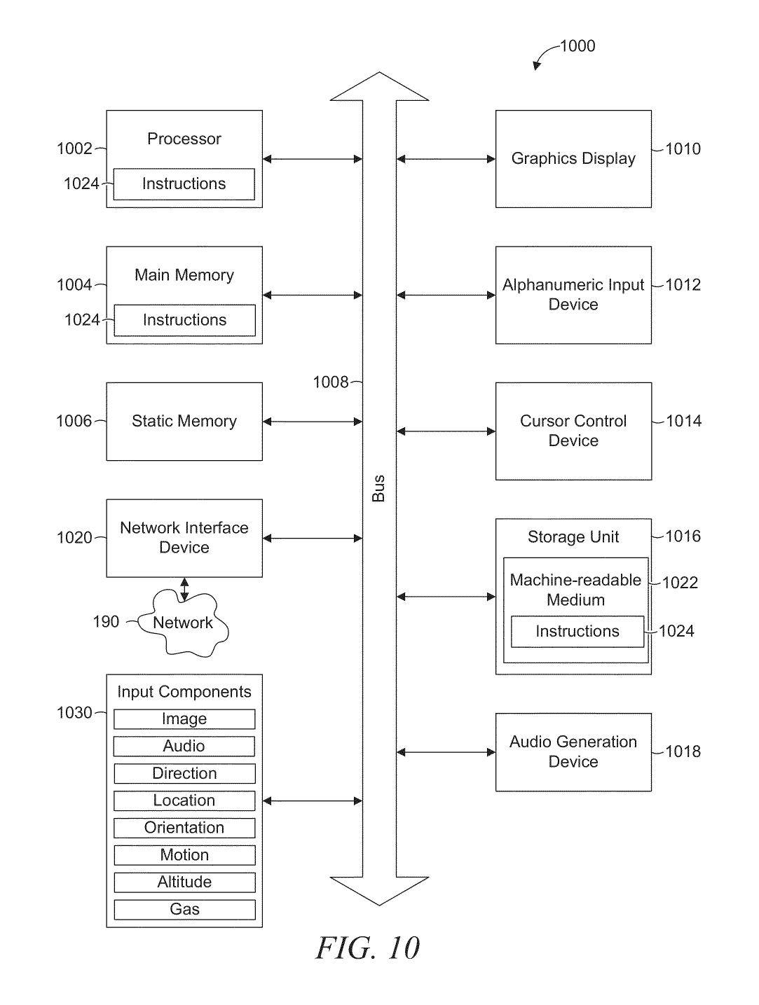

FIG. 1 is a network diagram illustrating a network environment 100 suitable to present one or more item recommendations, according to some example embodiments. The network environment 100 includes a recommendation machine 110, a database 115, and devices 130 and 150, all communicatively coupled to each other via a network 190. The recommendation machine 110 and the devices 130 and 150 may each be implemented in a computer system, in whole or in part, as described below with respect to FIG. 10.

Also shown in FIG. 1 are users 132 and 152. One or both of the users 132 and 152 may be a human user (e.g., a human being), a machine user (e.g., a computer configured by a software program to interact with the device 130), or any suitable combination thereof (e.g., a human assisted by a machine or a machine supervised by a human). The user 132 is not part of the network environment 1 but is associated with the device 130 and may be a user of the device 130. For example, the device 130 may be a desktop computer, a vehicle computer, a tablet computer, a navigational device, a portable media device, or a smart phone belonging to the user 132. Likewise, the user 152 is not part of the network environment 100, but is associated with the device 150. As an example, the device 150 may be a desktop computer, a vehicle computer, a tablet computer, a navigational device, a portable media device, or a smart phone belonging to the user 152.

Any of the machines, databases e.g., database 115), or devices (e.g., devices 130 or 150) shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIG. 10. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the recommendation machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” shall be taken to include any intangible medium that is capable of storing, encoding, or carrying instructions for execution by a machine, and includes digital or analog communication signals or other intangible media to facilitate communication of such software.

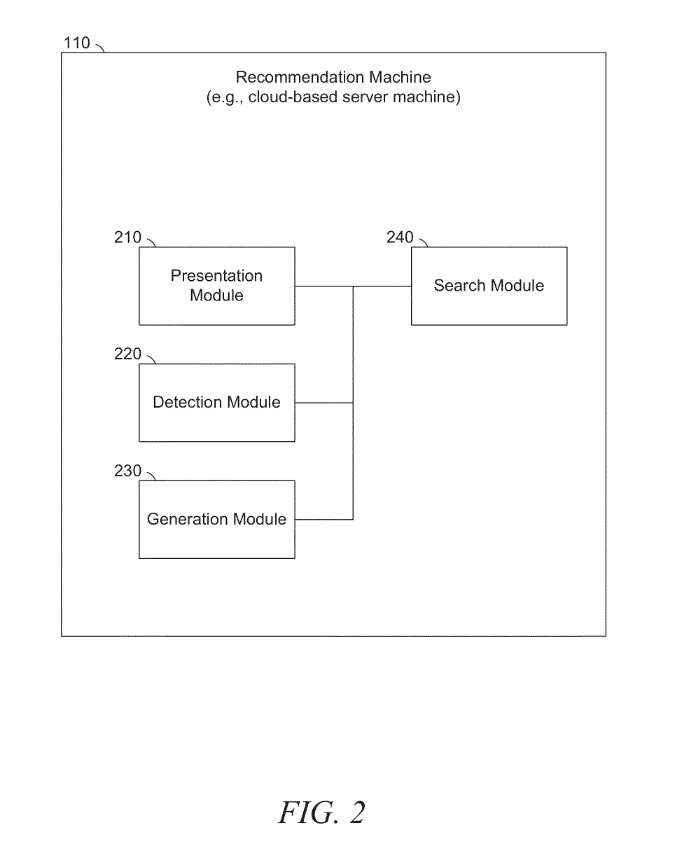

FIG. 2 is a block diagram depicting a recommendation machine 110, according to some example embodiments. The recommendation machine 110 may include a presentation module 210, a detection module 220, a generation module 230, and a search module 240.

In various example embodiments, the presentation module 210 may be configured to present a view item page that is descriptive of an item (e,g., “For example, an item currently viewed by the user 132”). The view item page may include a description of the item and an image of the item. The view item page may include a control operable by a user (e.g., user 132) to display recommendations of items similar to the item described by the view item page (e.g., the item currently viewed by the user 132).

In various example embodiments, the detection module 220 may be configured to detect that the user (e.g., user 132) operated the control included in the view item page that describes the item currently viewed by the user (e.g., user 132). Operation of the control may include the user (e.g., user 132) clicking on a button included in the view item page that describes the item currently viewed by the user (e.g., user 132).

In various example embodiments, the generation module 230 may be configured to generate recommendations of items similar to the item described by the view item page (e.g., the item currently viewed by the user 132). The search module 240 may determine the item similar to the item described by the view item page (e.g., the item currently viewed by the user 132), as further described below. The generating of the recommendations may be performed by the generation module 320 in response to the detection module 220 detecting that the user (e.g., user 132) operated the control included in the view item page, such as the user clicking on the button included in the view item page via the device. The recommendations may include a description of the similar items, an image of the similar items, a set of links to view item pages of the similar items, or any suitable combination thereof. Moreover, the presentation module 210 may be further configured to present the generated recommendations of the items similar to the item described by the view item page, the generation performed by the presentation module 210 in response to the operation of the control. In various example embodiments, the generation module 230 may be further configured to access a view history database that tracks previous users (e.g., user 152) that viewed the view item page of the item currently viewed by the user (e.g., user 132). The generating of the recommendations by the generation module 230 may be based on the view history database, as further described below.

In various example embodiments, the search module 240 may be configured to perform a search based on attributes of the item described by the view item page. The search module 240 may determine the items similar to the item described by the view item page based on the performed search. The search module 240 may identify items that share an item characteristic with the item described by the view item page. For instance, the search module 240 may search for similar items based on a brand, a category, a type, a function served by, and a price of the item described by the view item page. As a result, the items similar to the item described by the view item page may share at least one attribute with the item described by the view item page. In various example embodiments, search module 240 may be further configured to retrieve links to the items similar to the item described by the view item page. The links retrieved by the search module 240 may be generated as recommendations by the generation module 320. The links may be operable to display view item pages of the items similar to the item described by the view item page. In various example embodiments, the presentation module 210 may display the retrieved links to the similar items alongside a description of the similar items, an image of the similar items, or any suitable combination thereof.

In various example embodiments, detection module 220 may be further configured to receive a further request to view a similar item among the recommendations of the items similar to the item described by the view item page. The further request may be received from a device of the user (e.g., user 132) as result of clicking on a link from the set of links included in the recommendations. In response, the presentation module 210 may be further configured to present the further view item page that is descriptive of the similar item in response to the further request.

In various example embodiments, the detection module 220 is further configured to receive search criteria from a device (e.g., device 130) of the user (e.g., user 132). The search criteria may be used by the search module 240 to retrieve the view item page that is descriptive of the item currently viewed by the user (e.g., user 132). As such, the detection module 220 may receive the receive search criteria prior to the presentation module 210 presenting the view item page that is descriptive of the item currently viewed by the user (e.g., user 132). In various example embodiments, prior to the presentation module 210 presenting the view item page that is descriptive of an item, the search module 240 may be configured to retrieve search results that reference a list of items based on the search criteria received at the detection module 220. The list of items may include the item described by the view item page currently viewed by the user (e.g., user 132). In various example embodiments, the search module 240 may determine that the list of items each has at least one term included in its description that matches the search criteria. In various example embodiments, the presentation module 210 may be further configured to present the search results within a result page to the user (e.g., user 132) via the device (e.g., device 130) of the user (e.g., user 132). In various example embodiments, the detection module 220 may be further configured to receive a request to view the description of the item and the presentation module 210 may be configured to present the view item page that is descriptive of the item in response to the detection module 220 receiving the request.

In various example embodiments, the generation module 230 is further configured to access a search history database of previous users (e.g., user 152) that viewed the view item page of the same item as the one presented in the view item page by the presentation module 210. The view history database may include records of previous users (e.g., user 152) that viewed the view item page of the same item as the one presented in the view item page by the presentation module 210, and then viewed a second view item page of a second item among the items similar to the item described by the view item page. Based on these records from the view history database, the search module 240 is further configured to determine that the previous users (e.g., user 152) that viewed the view item page of the same item as the one presented in the view item page by the presentation module 210, and then viewed the second view item page of the second item among the items similar to the item described by the view item page. The search module 240 may then perform the search for items similar to the item described by the view item page, including the second item, based on this determination. In various example embodiments, search module 240 may determine that a predetermined number of previous users (e.g., user 152) viewed the second view item page of the second item among the items similar to the item described by the view item page.

In various example embodiments, the search module 240 is further configured to receive search criteria through operation of a set of controls operable to receive search criteria. The set of controls may be displayed separately from the control included in the view item page. In some instances, the set of controls may he displayed along with the generated recommendations presented to the user (e.g., user 132) by the presentation module 210. The search criteria may include item attributes absent from the item described by the view item page. For instance, the item attributes absent from the item may not be present in the actual item itself (e.g., the item described by the view item page). The various example embodiments, the set of controls each represent an item attribute to be used as search criteria. The set of controls may each be selectable by the user to indicate which item attributes are to be used as search criteria by the search module 240. Moreover, the set of controls may be pre-selected based on attributes of the item described in the view item page. In response to receiving the search criteria, the search module 240 may be further configured to perform a further search based on the search criteria. The generation module 230 may generate recommendations of items similar to the item described by the view item page based on the further search performed by the search module 240.

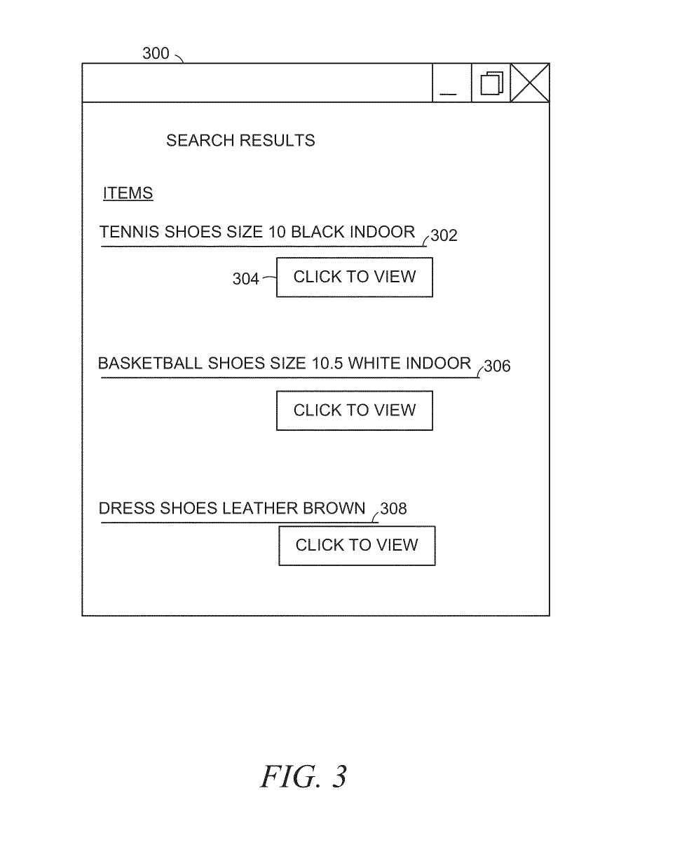

FIG. 3 is an example user interface 300 displaying a list of items, according to some example embodiments. The list of items may include an item 302, an item 306, and an item 308. Moreover, each item may include a control operable by the user e.g., user 132) to view an item page corresponding to the item. For instance, item 302 has a control 304 labeled “click to view” which will enable the user (e.g., user 132) to view the item page for item 302. In various example embodiments, the list of items, including item 302, item 306, and item 308, may be referenced by the search results retrieved by the search module 240.

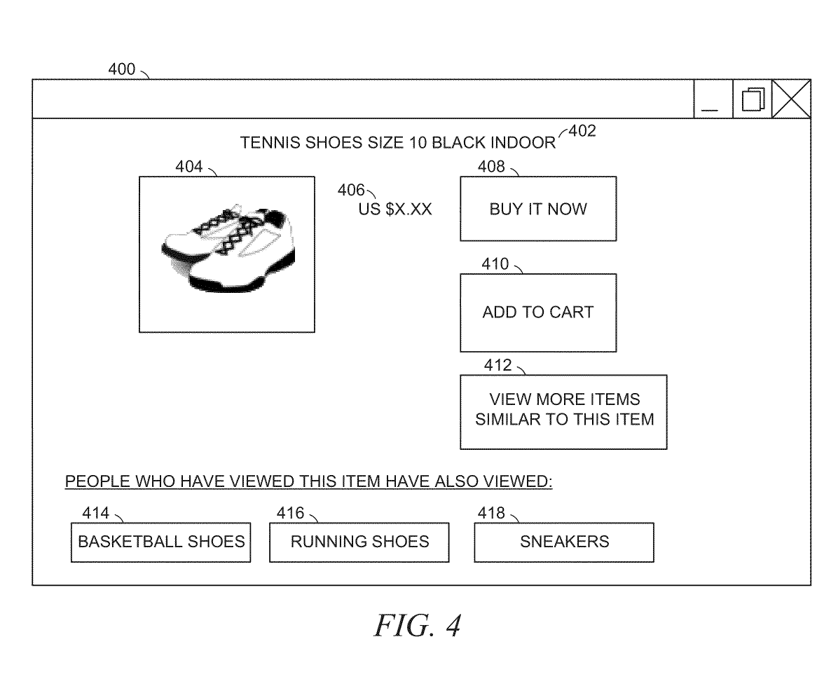

FIG. 4 is an example user interface displaying a view item page 400, according to some example embodiments. The view item page 400 may include a description of the item 402, an image of the item 404, a price of the item 406, a control to enable purchase of the item 408, a further control to enable purchase of the item 410, and a control 412 operable to view items that are similar to the item depicted in the view item page 400. Upon operation of the control 412, the generation module 230 may generate recommendations of items similar to the item described by the view item page 400. In various example embodiments, the view item page 400 may further include a first link 414, a second link 416, and a third link 418. Each of the links 414, 416, and 418 may be a control operable to view recommendations of items similar to the item described by the view item page 400. As a result, upon operation of any of the links 414, 416, and 418, the generation module 230 may generate the recommendations of items similar to the item described by the view item page 400. For instance, the first link 414 may be operable to view an item page of an item described by the first link 414. Likewise, the second link 416 may be operable to view an item of an item described by the second link 416. Lastly, the third link 418 may be operable to view an item page of an item described by the third link 418.

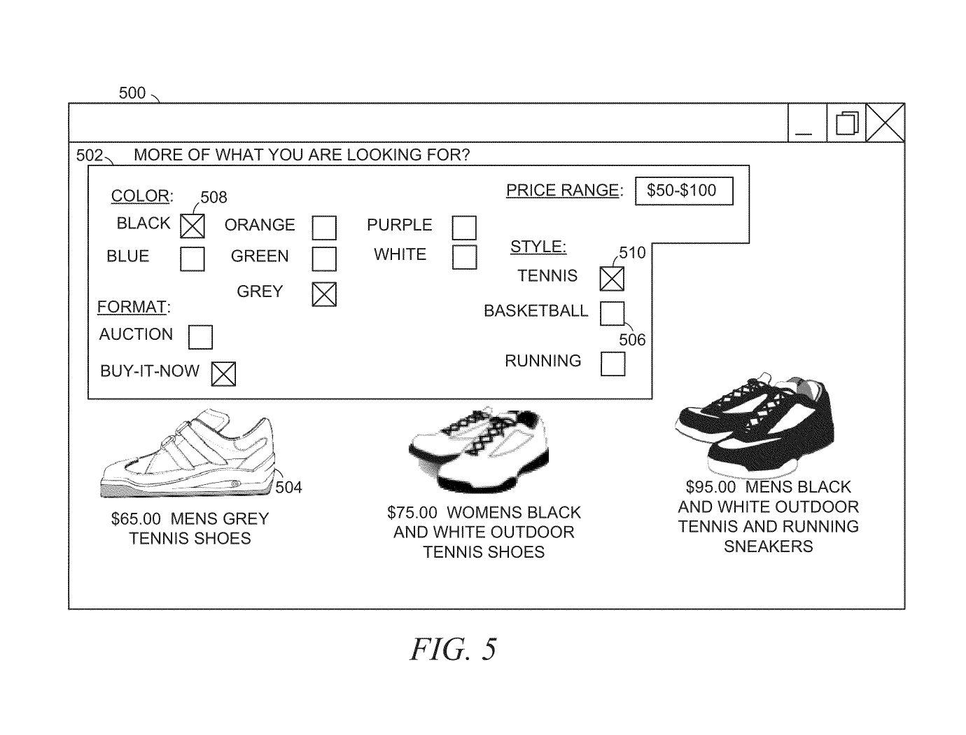

FIG. 5 is an example user interface 500 displaying generated recommendations of items similar to the item described by the view item page 400, according to some example embodiments. The example user interface 500 of generated recommendations of items similar to the item described by the view item page 400 may include links to the recommended items. For example, a link to grey tennis shoes 504 may be presented to the user (e.g., user 132). The example user interface 500 may include a set of controls 502 operable to receive search criteria from the user (e.g. user 132). The search criteria may include item attributes absent from the item described by the view item page 400. For example, the set of controls 502 may specify basketball shoes 506, an attribute that is absent from the view item page 400 which describes a pair of tennis shoes. Moreover, the set of controls may be pre-selected based on attributes of the item described by the view item page 400. For instance, search criteria corresponding to the color black 508 and the style tennis 510 may be pre-selected based on attributes of the item described by the view item page 400.

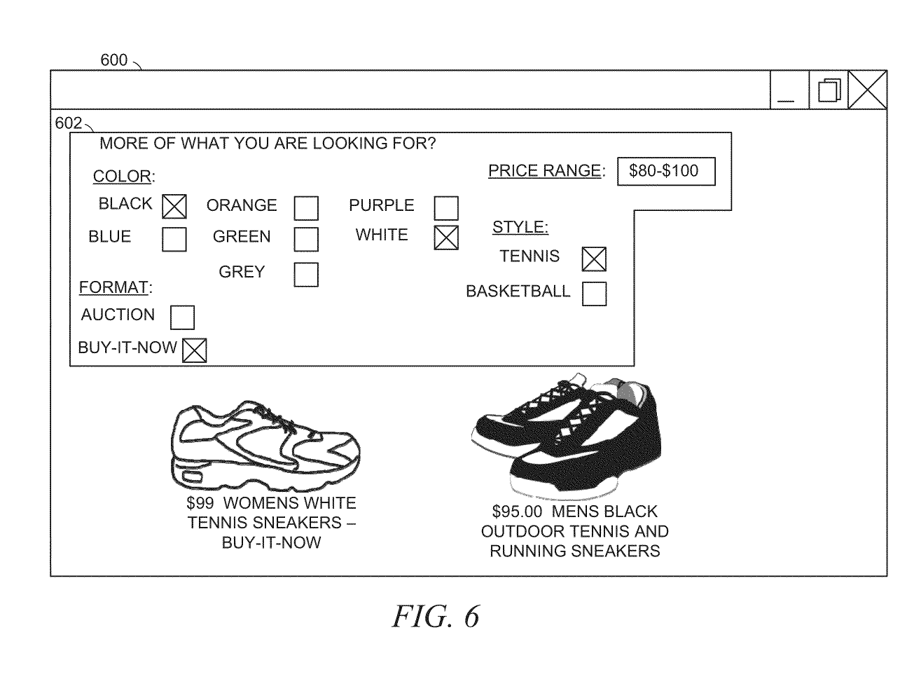

FIG. 6 is an example user interface 600 displaying further generated recommendations of items similar to the item described by the view item page 400, according to some example embodiments. The further generated recommendations of items may result from receiving the search criteria via operation of the set of controls 602. The search module 240 may perform a further search to retrieve the recommended items based on the received search criteria. Moreover, the generation module 230 may generate the further recommendations of items displayed in the user interface 600 based on the further search performed by the search module 240.

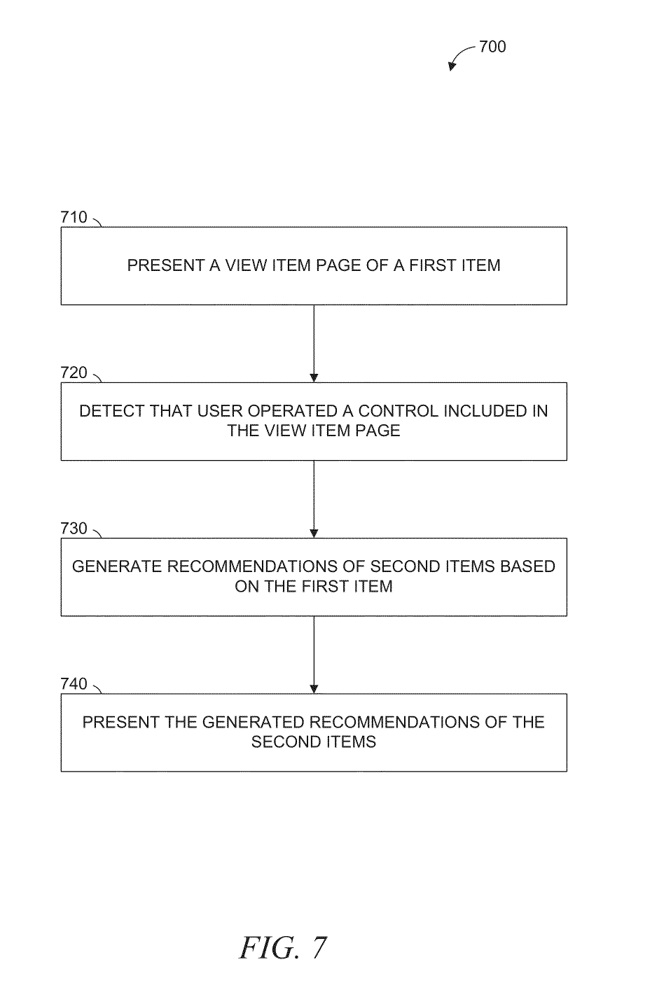

FIG. 7 is a flowchart illustrating a method 700 for presenting recommendations, according to some example embodiments. At step 710, the presentation module 210 may be configured to present a view item page 400 that is descriptive of first item. The view item page 400 may include a control 412 operable by a user (e.g., user 132) to display recommendations of items similar to the first item described by the view item page 400.

At step 720, the detection module 220 may be configured to detect that the user (e.g., user 132) operated the control 412 included in the view item page 400 that describes the first item.

At step 730, the generation module 230 may be configured to generate recommendations of second items similar to the first item described by the view item page 400. The generating of the recommendations may be performed by the generation module 230 in response to the detection module 220 detecting that the user (e.g., user 132) operated the control 412 included in the view item page 400.

At step 740, the presentation module 210 may be further configured to present the generated recommendations of the second items similar to the first item described by the view item page 400, the generation performed by the presentation module 210 in response to the operation of the control 412.

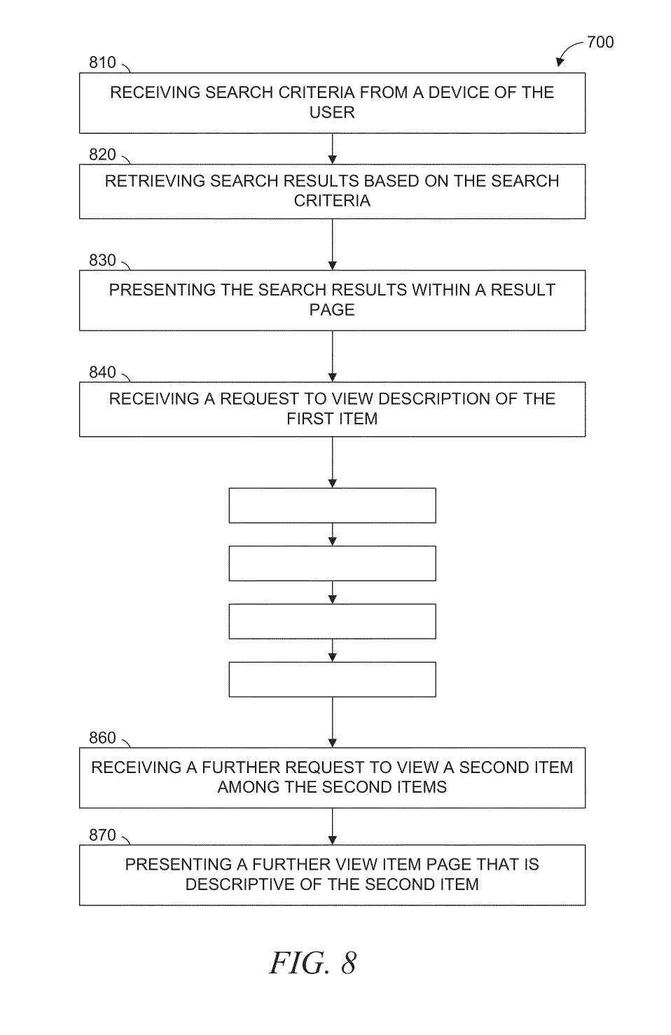

FIG. 8 is a flowchart illustrating the method 700 for presenting recommendations, according to some example embodiments. At step 810, the detection module 220 is further configured to receive search criteria from a device 130 of the user 132 prior to step 710 in which the presentation module 210 presents the view item page 400 that is descriptive of the first item. The search criteria may be used by the search module 240 to retrieve the view item page 400 that is descriptive of first the item.

At step 820, the search module 240 may be configured to retrieve search results that reference a list of items based on the search criteria received at the detection module 220. The list of items may include the first item described by the view item page 400. In various example embodiments, the search module 240 may determine the list of items each have at least one term included in its description that matches the search criteria.

At step 830, the presentation module 210 may be further configured to present the search results within a result page to the user 132 via the device 130 of the user 132.

At step 840, the detection module 220 may be further configured to receive a request to view the description of the first item and the presentation module 210 may be configured to present the view item page 400 that is descriptive of the first item in response to the detection module 220 receiving the request.

At step 860, detection module 220 may be further configured to receive a further request to view a second item among the recommended second items.

At step 870, the presentation module 210 may be further configured to present the further view item page 400 that is descriptive of the second item in response to the further request.

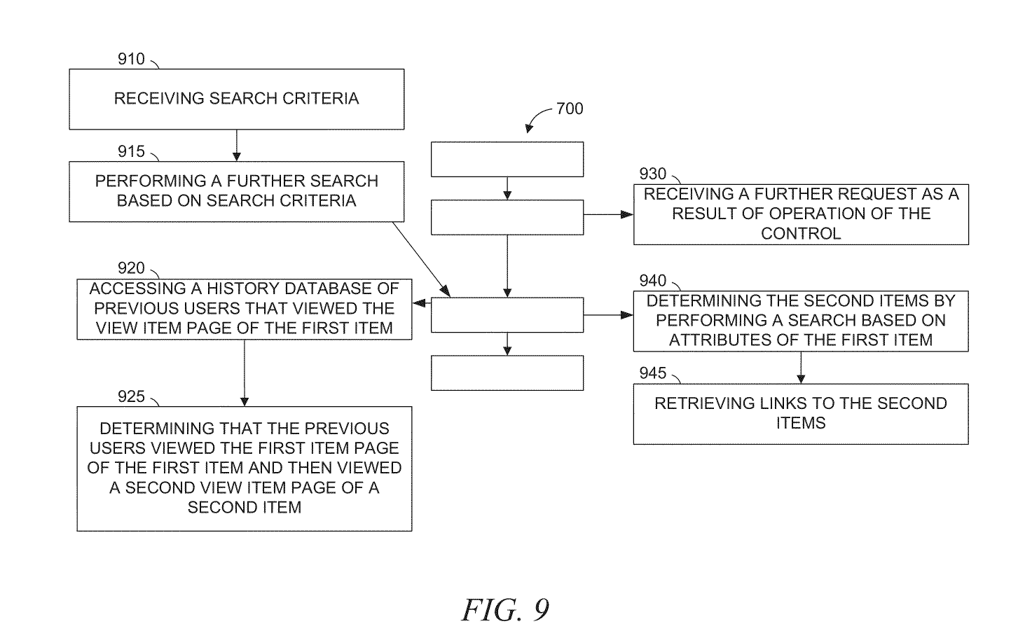

FIG. 9 is a flowchart illustrating the method 700 for presenting recommendations, according to some example embodiments. At step 910, the search module 240 is further configured to receive search criteria through operation of a set of controls 602 operable to receive search criteria. The set of controls 602 may be displayed separately from the control 412 included in the view page. In some instances, the set of controls 602 may be displayed in the result page presented to the user 132. The search criteria may include item attributes absent from the item described by the view item page 400.

At step 915, the search module 240 may perform a further search based on the search criteria. The generation module 230 may generate recommendations of the second items based on the further search performed by the search module 240.

At step 920, the generation module 230 is further configured to access a search history database of previous users (e.g., user 152) that viewed the view item page 400 of the same item as the first item presented in the view item page 400 by the presentation module 210. The generating of recommendations of second items similar to the first item described by the view item page 400 by the generation at step 730 may include the accessing the search history database.

At step 925, the search module 240 is further configured to determine that the previous users (e.g., user 152) that viewed the view item page 400 of the same item as the first item presented in the view item page 400 by the presentation module 210, and then viewed a second view item page 400 of the second item. The second item may be included among the second items generated in the recommendation by the generation module 230 at step 730.

At step 930, the detection module 220 is further configured to receive a further request that originated from the device 130 of the user 132 as a result from the operation of the control 412 included in the view item page 400 displayed by the presentation module 210 at step 710. The further request may cause the generation module 230 to generate recommendations of the second items similar to the first item described by the view item page 400.

At step 940, the search module 240 may be configured to perform a search based on attributes of the first item described by the view item page 400. The search module 240 may determine the second items similar to the item described by the view item page 400 based on the performed search. As a result, the second items may share at least one attribute with the item described by the view item page 400. The generating of recommendations of second items similar to the first item described by the view item page 400 by the generation at step 730 may include the performing the search based on attributes of the first item described by the view item page 400.

At step 945, search module 240 may be further configured to retrieve links to the items similar to the item described by the view item page 400. The links retrieved by the search module 240 may be generated as recommendations by the generation module 320.

FIG. 10 is a block diagram illustrating components of a machine 1000, according to some example embodiments, able to read instructions 1024 from a machine-readable medium 1022 (e.g. a machine-readable storage medium, a computer-readable storage medium, or any suitable combination thereof) and perform any one or more of the methodologies discussed herein, in whole or in part. Specifically, FIG. 10 shows the machine 1000 in the example form of a computer system within which the instructions 1024 (e.g., software, a program, an application, an applet, an app, or other executable code) for causing the machine 1000 to perform any one or more of the methodologies discussed herein may be executed, in whole or in part. In alternative example embodiments, the machine 1000 operates as a standalone device (e.g., device 130) or may be connected (e.g., networked) to other machines. In a networked deployment, the machine 1000 may operate in the capacity of a server machine or a client machine in a server-client network environment, or as a peer machine in a distributed (e.g., peer-to-peer) network environment. The machine 1000 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1024, sequentially or otherwise, that specify actions to be taken by that machine. Further, while only a single machine is illustrated, the term “machine” shall also be taken to include any collection of machines that individually or jointly execute the instructions 1024 to perform all or part of any one or more of the methodologies discussed herein.

The machine 1000 includes a processor 1002 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1004, and a static memory 1006, which are configured to communicate with each other via a bus 1008. The processor 1002 may contain microcircuits that are configurable, temporarily or permanently, by some or all of the instructions 1024 such that the processor 1002 is configurable to perform any one or more of the methodologies described herein, in whole or in part. For example, a set of one or more microcircuits of the processor 1002 may be configurable to execute one or more modules (e,g., software modules) described herein.

The machine 1000 may further include a graphics display 1010 (e.g., a plasma display panel (PDP), a light emitting diode (LED) display, a liquid crystal display (LCD), a projector, a cathode ray tube (CRT), or any other display capable of displaying graphics or video). The machine 1000 may also include an alphanumeric input device 1012 (e.g., a keyboard or keypad), a cursor control device 1014 (e.g., a mouse, a touchpad, a trackball, a joystick, a motion sensor, an eye tracking device, or other pointing instrument), a storage unit 1016, an audio generation device 1018 (e.g., a sound card, an amplifier, a speaker, a headphone jack, or any suitable combination thereof), and a network interface device 1020.

The storage unit 1016 includes the machine-readable medium 1022 (e.g., a tangible and non-transitory machine-readable storage medium) on which are stored the instructions 1024 embodying any one or more of the methodologies or functions described herein. The instructions 1024 may also reside, completely or at least partially, within the main memory 1004, within the processor 1002 (e.g., within the processor's cache memory), or both, before or during execution thereof by the machine 1000. Accordingly, the main memory 1004 and the processor 1002 may be considered machine-readable media (e.g., tangible and non-transitory machine-readable media). The instructions 1024 may be transmitted or received over the network 190 via the network interface device 1020. For example, the network interface device 1020 may communicate the instructions 1024 using any one or more transfer protocols (e.g., hypertext transfer protocol (HTTP)).

In some example embodiments, the machine 1000 may be a portable computing device, such as a smart phone or tablet computer, and have one or more additional input components 1030 (e.g., sensors or gauges). Examples of such input components 1030 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components 1030 may be accessible and available for use by any of the modules described herein.

As used herein, the term “memory” refers to a machine-readable medium 1022 able to store data temporarily or permanently and may be taken to include, but not be limited to, random-access memory (RAM), read-only memory (ROM), buffer memory, flash memory, and cache memory. While the machine-readable medium 1022 is shown in an example embodiment to be a single medium, the term “machine-readable medium” should be taken to include a single medium or multiple media (e.g., a centralized or distributed database, or associated caches and servers) able to store instructions 1024. The term “machine-readable medium” shall also be taken to include any medium, or combination of multiple media, that is capable of storing the instructions 1024 for execution by the machine 1000, such that the instructions 1024, when executed by one or more processors of the machine 1000 (e.g., processor 1002), cause the machine 1000 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor 1002 or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors e.g., comprising different hardware modules) at different times. Software may accordingly configure a processor 1002, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors (e.g., processor 1002).

Similarly, the methods described herein may be at least partially processor-implemented, a processor 1002 being an example of hardware. For example, at least some of the operations of a method may be performed by one or more processors (e.g., processor 1002) or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API).

The performance of certain operations may be distributed among the one or more processors (e.g., processor 1002), not only residing within a single machine (e.g., machine 1000), but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Sonic portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
presenting a view item page that is descriptive of a first item in response to a request by a user to view a description of the first item,
the view item page including a control operable by the user to display recommendations of second items similar to the first item described by the view item page;
detecting that the user operated the control included in the view item page that describes the first item;
generating a set of recommendations of the second items based on the first item described by the view item page,
the generating of the set of recommendations being performed by a processor of a machine in response to the detecting that the user operated the control; and
presenting the generated set of recommendations of the second items in response to operation of the control.

2. The method of claim 1, further comprising:
prior to the presenting of the view item page, receiving search criteria from a device of the user;
retrieving search results that reference a set of first items that include the first item, and the retrieving of the search results being based on the search criteria;
presenting the search results within a result page to the user via the device of the user, the result page being configured to enable the user to initiate the request to view the description of the first item; and
receiving the request to view the description of the first item, the request being initiated by the user through use of the result page; wherein the presenting of the view item page is in response to the receiving of the request initiated by the user.

3. The method of claim 1, wherein the detecting that the user operated the control includes receiving a further request that originated from a device of the user as a result from the operation of the control included in the view item page displayed by the device.

4. The method of claim 1, further comprising:
receiving a further request to view a second item among the recommended second items; and
presenting a further view item page that is descriptive of the second item in response to the further request.

5. The method of claim 1, wherein the generating of the set of recommendations of the second items includes:
determining the second items by performing a search based on attributes of the first item, the second items sharing at least one attribute with the first item; and
retrieving links to the second items that share at least one attribute with the first item.

6. The method of claim 5, wherein the view item page of the first item is a first view item page, and wherein the generating of the set of recommendations of the second items based on the first item includes accessing a view history database that tracks previous users that viewed the first view item page, and the generating of the set of recommendations is based on the view history database.

7. The method of claim 6, further comprising:
determining that the previous users viewed the view item page of the first item and then viewed a second view item page of a second item among the second items based on the view history database.

8. The method of claim 1, further comprising:
receiving search criteria through operation of a set of controls operable to receive the search criteria from the user;
wherein the generating of the set of recommendations includes performing a search based on the search criteria.

9. The method of claim 8, wherein the presenting the view item page includes presenting the set of controls separately from the control included in the view item page.

10. The method of claim 8, wherein the search criteria include item attributes absent from the first item, the item attributes not present in the first item.

11. The method of claim 1, wherein the presenting the set of recommendations of the second items includes causing the set of recommendations to be displayed by a device of the user in response to detecting that the user has operated the control interface.

12. The method of claim 1, wherein the view item page that is descriptive of the first item includes the description of the first item and a picture of the first item.

13. A system comprising:
a presentation module configured to present a view item page that is descriptive of a first item in response to a request by a user to view a description of the first item,
the view item page including a control operable by the user to display recommendations of second items similar to the first item described by the view item page;
a detection module configured to detect that the user operated the control included in the view item page that describes the first item;
a processor configured by a generation module to generate a set of recommendations of the second items based on the first item described by the view item page and in response to the detecting that the user operated the control; and
the presentation module further configured to present the generated set of recommendations of the second items in response to operation of the control.

14. The system of claim 13, wherein
the detection module is further configured to receive search criteria from a device of the user prior to the view item page being presented by the presentation module; and the system further comprises:
a search module configured to retrieve search results that reference a set of first items that include the first item, and the retrieving of the search results being based on the search criteria; wherein
the presentation module is further configured to present the search results within a result page to the user via the device of the user, the result page being configured to enable the user to initiate the request to view the description of the first item; and
the detection module is further configured to receive the request to view the description of the first item, the request being initiated by the user through use of the result page; the presenting of the view item page by the presentation module is in response to the receiving of the request initiated by the user.

15. The system of claim 13, wherein the search module is further configured to:
determine the second items by performing a search based on attributes of the first item, the second items sharing at least one attribute with the first item; and
retrieve links to the second items that share at least one attribute with the first item; and wherein the generation module is further configured to generate the links retrieved by the search module.

16. The system of claim 15, wherein the generation module is further configured to:
access a view history database that tracks previous users that viewed the view item page of the first item, the generating of the set of recommendations being based on the view history database.

17. The system of claim 16, wherein the search module is further configured to:
determine that the previous users viewed the view item page of the first item and then viewed a second view item page of a second item among the second items.

18. The system of claim 1, wherein the search module is further configured to:
receive search criteria through operation of a set of controls operable to receive the search criteria from the user, the set of controls displayed separately from the control included in the view item page, and to perform a search based on the search criteria.

19. The system of claim 18, wherein the search criteria include item attributes absent from the first item, the item attributes not present in the first item.

20. A non-transitory machine-readable medium storing instructions that, when executed by one or more processors of a machine, cause the machine to perform operations comprising:
presenting a view item page that is descriptive of a first item in response to a request by a user to view a description of the first item,
the view item page including a control operable by the user to display recommendations of second items similar to the first item described by the view item page;
detecting that the user operated the control included in the view item page that describes the first item;
generating a set of recommendations of the second items based on the first item described by the view item page in response to the detecting that the user operated the control; and
presenting the generated set of recommendations of the second items in response to operation of the control.
